(19) United States
(12) Patent Application Publication
(10) Pub. No.: US 2020/0209909 A1
(43) Pub. Date: Jul. 2, 2020

(54) OPTICAL PHASED ARRAY FOURIER TRANSFORM PROCESSOR

(71) Applicant: ROCKLEY PHOTONICS LIMITED, London (GB)

(72) Inventors: Andrew George Rickman, Marlborough (GB); Hooman Abediasl, Pasadena, CA (US)

(21) Appl. No.: 16/779,526

(22) Filed: Jan. 31, 2020

Related U.S. Application Data
(63) Continuation-in-part of application No. 16/727,847, filed on Dec. 26, 2019.
(60) Provisional application No. 62/785,611, filed on Dec. 27, 2018.

(51) Int. Cl. G06E 1/04

(52) U.S. Cl. CPC G06E 1/04

(57) ABSTRACT

An optical processor. In some embodiments, the optical processor includes a free propagation region; a plurality of input waveguides, coupled to an input aperture of the free propagation region; a plurality of output waveguides, coupled to an output aperture of the free propagation region; a first modulator, on one of the input waveguides; and an optical detector, on one of the output waveguides.

### CROSS-REFERENCE TO RELATED APPLICATION(S)

The present application is a continuation-in-part of U.S. patent application Ser. No. 16/727,847, filed Dec. 26, 2019, entitled “OPTICAL PHASED ARRAY FOURIER TRANSFORM PROCESSOR”, which claims priority to and the benefit of U.S. Provisional Application No. 62/785,611 filed Dec. 27, 2018, entitled “INTEGRATED OPA FOURIER TRANSFORMER PROCESSOR”. The entire contents of both of the patent applications identified in this paragraph are incorporated herein by reference.

### FIELD

One or more aspects of embodiments according to the present disclosure relate to optical systems, and more particularly to an optical processor.

### BACKGROUND

Certain computations, such as the calculation of an approximate Fourier transform, may be relatively slow, and consume significant energy and computing resources, if performed using a digital computer.

Thus, there is a need for an improved system and method for performing calculations.

### SUMMARY

According to an embodiment of the present invention, there is provided an optical processor, including: a free propagation region; a plurality of input waveguides, coupled to an input aperture of the free propagation region; a plurality of output waveguides, coupled to an output aperture of the free propagation region; a first modulator, on one of the input waveguides; and an optical detector, connected to one of the output waveguides.

In some embodiments, 0.75 microns times a minimum separation between the input aperture and the output aperture exceeds the square of a width of the input aperture.

In some embodiments, 0.25 microns times the minimum separation between the input aperture and the output aperture exceeds the square of the width of the input aperture.

In some embodiments, the first modulator includes a phase modulator.

In some embodiments, the first modulator includes an amplitude modulator.

In some embodiments, the first modulator further includes a phase modulator.

In some embodiments, the optical processor further includes an input splitter configured to distribute light from a light source to the input waveguides.

In some embodiments, the spacing of the input waveguides at the input aperture is uniform to within 50%.

In some embodiments, an average pitch of the input waveguides at the input aperture is less than 1.5 microns.

In some embodiments, an average pitch of the input waveguides at the input aperture is greater than 5 microns, and wherein a first contiguous subset of the output waveguides are connected to a first subsystem, and a second contiguous subset of the output waveguides are connected to a second subsystem.

In some embodiments, the first subsystem or the second subsystem is a detector array.

In some embodiments, the first subsystem or the second subsystem is an optical signal processing system.

In some embodiments, the input aperture is concave.

In some embodiments, the input aperture is convex.

In some embodiments, the output aperture is concave.

In some embodiments, the output aperture is convex.

In some embodiments, the input aperture is straight to within 0.5 microns.

In some embodiments, the optical detector includes a photodetector.

In some embodiments, the optical detector includes a phase sensitive detector.

In some embodiments, the optical processor further includes a phase modulated local oscillator connected to the phase sensitive detector, wherein the phase sensitive detector includes: a combiner connected to a signal input of the phase sensitive detector and to the phase modulated local oscillator, and a photodetector connected to the combiner.

### BRIEF DESCRIPTION OF THE DRAWINGS

These and other features and advantages of the present disclosure will be appreciated and understood with reference to the specification, claims, and appended drawings wherein:

FIG. 1 is a schematic illustration of an optical processor, according to an embodiment of the present disclosure;

FIG. 2 is a block diagram of a portion of an optical processor, according to an embodiment of the present disclosure;

FIG. 3A is a block diagram of an optical detector, according to an embodiment of the present disclosure; and

FIG. 3B is a block diagram of an optical detector, according to an embodiment of the present disclosure.

### DETAILED DESCRIPTION

The detailed description set forth below in connection with the appended drawings is intended as a description of exemplary embodiments of an optical processor provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

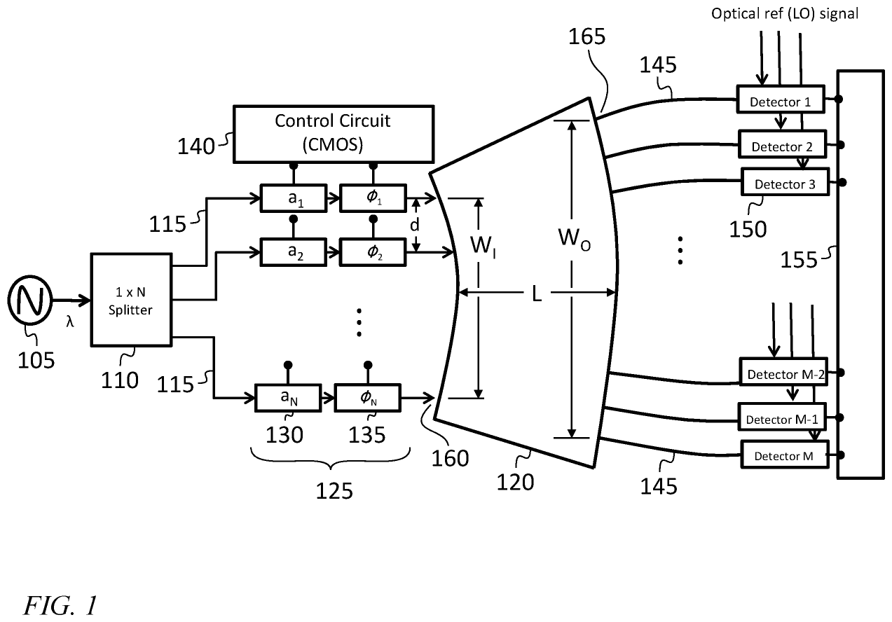

Referring to FIG. 1, in some embodiments, an optical processor includes a light source 105 feeding a splitter, or “input splitter” (e.g., a 1×N splitter) 110 which feeds, through a plurality of input waveguides 115 (e.g., N input waveguides 115, N being a positive integer), a free propagation region 120. Each of a plurality of optical modulators 125 (each of which may include an amplitude modulator 130 and a phase modulator 135, and which may be controlled by a control circuit 140) may be on (i.e., configured to modulate light propagating in) a respective one of the input waveguides 115. The free propagation region 120 may have a plurality of output waveguides 145 (e.g., M output waveguides 145, M being a positive integer) each of which feeds a respective one of a plurality of optical detectors 150. Each of the optical detectors 150 may generate one or more electrical signals indicating one or more characteristics (e.g., the amplitude and the phase) of the light received by the optical detector 150; these electrical signals may be fed to a backbone electrical signal processing circuit 155, e.g., a digital signal processor (DSP). Either (i) the optical detector 150 may include an analog to digital converter, or (ii) the backbone electrical signal processing circuit 155 may include an array of analog to digital converters, so that further electrical signal processing may be performed digitally. In some embodiments a relatively low-powered light source 105 (having an output of 1 mW or less) may be sufficient for acceptable performance. The light source may generate light with a wavelength between 1.1 microns and 3.0 microns. In some embodiments the optical processor is constructed as a photonic integrated circuit (or “silicon photonics integrated circuit”) on a silicon substrate (e.g., on a silicon-on-insulator wafer), using large (e.g., 3-micron wide) waveguides (e.g., rib or strip waveguides). The free propagation region 120 in such an embodiment may be a slab waveguide.

In some embodiments, the free propagation region 120 has an input aperture 160, the input aperture being a portion of the boundary of the free propagation region 120 along which the input waveguides 115 launch light into the free propagation region 120. The input aperture 160 may have a width W_{I}. The input waveguides 115 may be substantially uniformly spaced within the input aperture 160 with a spacing, or “pitch”, d (measured from the center of one input waveguide 115 to the center of an adjacent input waveguide 115). In some embodiments, the spacing of the input waveguides 115 at the input aperture 160 is uniform to within 10%, i.e., for some “nominal” spacing, the spacing between any adjacent pair of input waveguides 115 is at least 0.9 times and at most 1.1 times the nominal spacing. In other embodiments, the spacing of the input waveguides 115 at the input aperture 160 is less uniform; e.g., it is uniform to within 20%, 30%, 40%, or 50%.

Similarly, in some embodiments the free propagation region 120 has an output aperture 165, the output aperture being a portion of the boundary of the free propagation region 120 along which the output waveguides 145 receive light from the free propagation region 120. Like the input waveguides 115, the output waveguides 145 may be substantially uniformly spaced within the output aperture 165, with a spacing measured from the center of one output waveguide 145 to the center of an adjacent output waveguide 145. In some embodiments, the spacing of the output waveguides 145 at the output aperture 165 is uniform to within 10%, i.e., for some “nominal” spacing, the spacing between any adjacent pair of output waveguides 145 is at least 0.9 times and at most 1.1 times the nominal spacing. In other embodiments, the spacing of the output waveguides 145 at the output aperture 165 is less uniform; e.g., it is uniform to within 20%, 30%, 40%, or 50%.

In some embodiments, the length L of the free propagation region 120 is sufficiently great that the Fraunhofer equation describes the electromagnetic field at the output aperture 165 to a good approximation, i.e., the electromagnetic field at the output aperture 165 is approximately proportional to the Fourier transform (FT) of the electromagnetic field at the input aperture. This may occur when the product of the length L of the free propagation region 120 and the wavelength of the light is significantly greater than the square of the width W_{I} of the input aperture 160. For example, for light with a wavelength of 1.5 microns, if 0.75 microns times a minimum separation between the input aperture 160 and the output aperture 165 exceeds the square of a width of the input aperture, then the product of the length L of the free propagation region 120 and the wavelength of the light is greater, by a factor of two, than the square of the width W_{I} of the input aperture 160. Similarly, if 0.25 microns times a minimum separation between the input aperture 160 and the output aperture 165 exceeds the square of a width of the input aperture, then the product of the length L of the free propagation region 120 and the wavelength of the light is greater, by a factor of six, than the square of the width W_{I} of the input aperture 160.

In such an embodiment, the optical processor may be used to calculate Fourier transforms. For example, to calculate the Fourier transform of a first function, the optical modulators 125 may be controlled (as discussed in further detail below) so that the electromagnetic field at the input aperture 160 approximates the first function (e.g., so that the electromagnetic field in each of the input waveguides 115 at the input aperture 160 is proportional to a corresponding sample of the first function). The electromagnetic field at the output aperture 165 may then be approximately proportional to the Fourier transform of the first function, and the light received from the free propagation region 120, by each of the output waveguides 145, may be a sample of the approximate Fourier transform.

The optical processor, in this mode of operation, may be capable of calculating approximate Fourier transforms at a rate limited primarily by the rate at which the optical modulators 125 (and their drive circuits) are capable of changing the electromagnetic field at the input aperture 160, and the bandwidths of the optical detectors 150 and the electronic circuits (e.g., sensing circuits and analog to digital converters) connected to them. In some embodiments, the bandwidths of these components may be 1 GHz or more, or 10 GHz, or several tens of GHz. In some embodiments, the optical processor calculates 1 billion Fourier transforms per second, or 10 billion Fourier transforms per second, or 30 billion Fourier transforms per second, or more. These rates of calculating Fourier transforms may be significantly greater than rates readily achievable, e.g., by digital processors performing fast Fourier transforms. Moreover, the total power consumption of the optical processor may be significantly less than that of a digital processor (e.g., a processor including a plurality of DSPs) with comparable processing power.

In some embodiments, the length L of the free propagation region 120 is not sufficiently great that the Fraunhofer equation describes the electromagnetic field at the output aperture 165 to a good approximation, or the input waveguides 115 may be non-uniformly spaced on the input aperture 160, or the output waveguides 145 may be non-uniformly spaced on the output aperture 165. In such an embodiment, the optical processor may perform a calculation different from a Fourier transform. For example, it may calculate a Green's function, or, in an embodiment in which the length L of the free propagation region 120 is not sufficiently great that the Fraunhofer equation describes the electromagnetic field at the output aperture 165 to a good approximation, the optical processor may, for example, perform an approximate calculation of the Fresnel diffraction integral.

In some embodiments the input aperture 160 may be concave and the output aperture 165 may be convex, as shown in FIG. 1. In other embodiments, either of these two apertures may be concave, convex, or substantially straight (e.g., straight to within 0.5 microns), or a combination of these possibilities (e.g., an aperture may be slightly concave, while also being straight to within 0.5 microns).

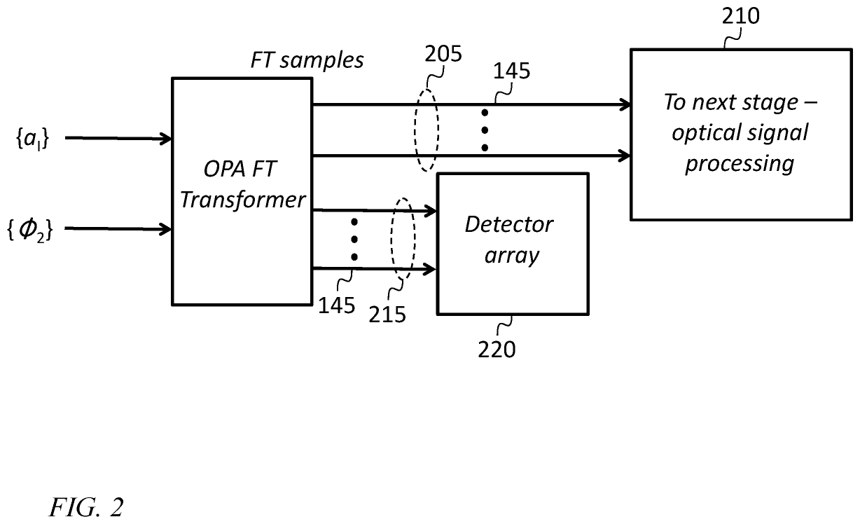

In some embodiments, the number N of input waveguides 115 determines the resolution of the Fourier transform in the input domain (e.g., in the domain of the spatial coordinate, e.g., x, or in the time domain, if the input function is a time domain function samples of which are produced by the optical modulators 125) and the number M of output waveguides 145 determines the resolution in the Fourier transform domain (e.g., the frequency domain, or the spatial frequency domain). If the spacing of the input waveguides 115 is sufficiently small, then it may be possible to use a larger spacing for the output waveguides without significant loss of accuracy in the calculated Fourier transform. In some embodiments, the spacing of the input waveguides 115 may be chosen to be sufficiently large (e.g., 5 microns or greater) that multiple similar or identical images are formed at the output aperture 165. This may occur when the spacing is greater than one half of the optical wavelength. For spacing greater than one half of the optical wavelength, it may be the case that the greater the spacing of the input waveguides 115, the smaller the center-to-center separation of the multiple images. Referring to FIG. 2, in some such embodiments, a first contiguous subset 205 of the output waveguides are connected to a first subsystem (e.g., an optical signal processing system 210), and a second contiguous subset 215 of the output waveguides 145 are connected to a second subsystem (e.g., an array 220 of optical detectors 150 (not shown individually in FIG. 2)). The optical signal processing system 210 may, for example, include an array of attenuators for implementing a filter function and an additional free propagation region for performing an inverse Fourier transform.

Each of the optical modulators 125 may (as mentioned above) include an amplitude modulator 130 (a₁, a₂ . . . a_{N} in FIG. 1) and a phase modulator 135 (Φ₁, Φ₂ . . . Φ_{N} in FIG. 1). These amplitude modulators 130 and phase modulators 135 may be any modulators suitable for modulating the amplitude and phase, respectively, of light propagating in the input waveguides 115. In some embodiments, one or more of the optical modulators 125 may be constructed differently (e.g., as a Mach-Zehnder interferometer with a phase modulator in each arm, with, e.g., a common-mode signal applied to the phase modulators resulting in phase modulation at the output of the Mach-Zehnder interferometer, and with a differential signal applied to the phase modulators resulting in amplitude modulation at the output of the Mach-Zehnder interferometer). In some embodiments, only the amplitude or only the phase of the light is modulated in one or more of the input waveguides 115. As mentioned above, a control circuit 140 may generate electrical control signals for the optical modulators 125. The control signals may be routed to the optical modulators 125 through conductive traces, which may cross some the input waveguides 115 (each of the input waveguides 115 may be covered in a cladding layer, and the conductive traces may be on top of the cladding layer, to prevent the conductive traces from interfering with the propagation of light in the input waveguides 115). Each of the modulators may consume a relatively small amount of power, so that the total power consumption of all of the optical modulators 125 may be less than 100 mW.

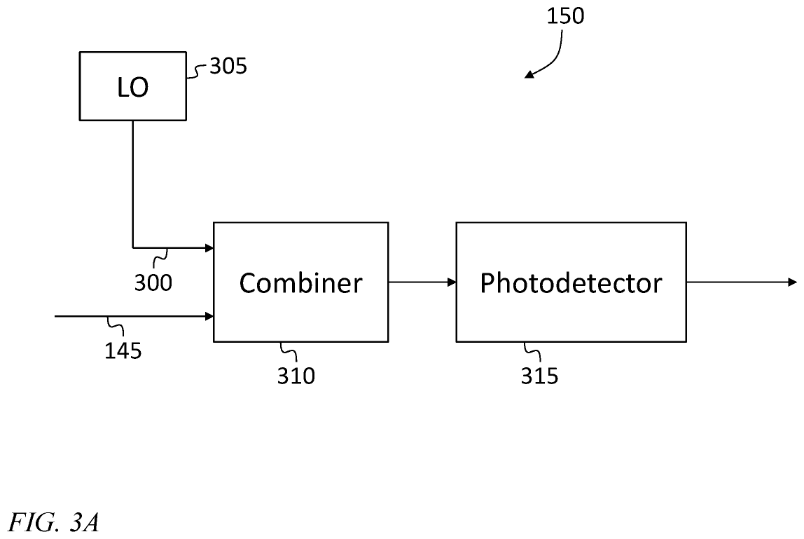

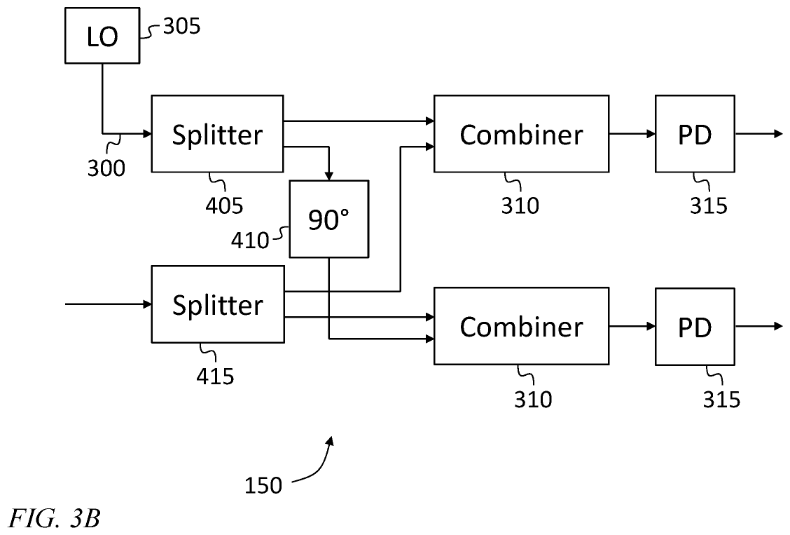

Each of the optical detectors 150 may have a signal input connected to one of the output waveguides 145 and may be capable (as mentioned above) of measuring the amplitude and phase of the light propagating in the output waveguide 145 to which it is connected. Each of the optical detectors 150 may be constructed in any of several ways. For example, referring to FIG. 3A, each of the optical detectors 150 may receive (at a local oscillator input 300) an optical reference signal, or “local oscillator” (LO) signal, from an optical local oscillator 305 (e.g. a phase modulated optical local oscillator, including a splitter each output of which is connected to a respective one of the optical detectors 150). The local oscillator signal may be combined, by an optical combiner 310, with the input signal (received by the optical detector 150 at the signal input, from the output waveguide 145 to which the optical detector 150 is connected), by an optical combiner 310, and detected by a photodetector (PD) 315 (e.g., a photodiode). The optical combiner 310 may be an MMI (for operation over a bandwidth of about 30 nm to 50 nm) or an adiabatic Y-junction for broader band (e.g., 500 nm bandwidth) operation. In some embodiments the light source 105 is tunable or capable of selecting from among a plurality of wavelengths (over a bandwidth of e.g., 500 nm); in some embodiments it is broadband and generates light at various wavelengths simultaneously.

The local oscillator signal may be phase-coherent with the light source 105. For example, it may be a laser that is phase-locked (e.g., by injection locking) to the light source, or it may be a portion of the light from the light source (e.g., split off from the light source before the splitter 110, or as an additional output of the splitter 110 (not shown in FIG. 1)). If a portion of the light produced by the light source is used, it may be amplified by a suitable optical amplifier. The local oscillator signal may be phase modulated or frequency shifted to make it possible for the optical detector 150 to measure both the amplitude and phase of the optical input signal. If the local oscillator signal is frequency shifted with respect to the light of the light source 105, then heterodyne detection may be used, e.g., the amplitude and phase of the light received by the optical detector 150 may be determined from the amplitude and phase of the (e.g., radio frequency) signal at the output of the photodetector 315. In some embodiments, in-phase and quadrature detection may be used to measure both the amplitude and phase of the optical input signal, as shown in FIG. 3B, in which a first splitter 405 and a 90-degree delay 410 produce two phases of the local oscillator signal, which are combined with the input signal (split into two paths by a second splitter 415) in two respective combiners 310 and detected by two respective photodetectors 315. In some embodiments only the amplitude of the Fourier transform is of interest, and each of the optical detectors 150 may be simply a photodetector.

As used herein, a “modulator” or “optical modulator” is any element or combination of elements capable of modulating light (e.g., modulating the amplitude or the phase of light). As such, a modulator may include, as components, other modulators (e.g., a modulator capable of modulating both amplitude and phase may include an amplitude modulator and a phase modulator). As used herein, an optical detector is any element capable of measuring characteristics of input light that it receives. As such, an optical detector may include, as components, other optical detectors, such as photodiodes.

Each of the control circuit 140 and the backbone electrical signal processing circuit 155 may be a processing circuit. The term “processing circuit” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated or co-packaged on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, the word “or” is inclusive, so that, for example, “A or B” means any one of (i) A, (ii) B, and (iii) A and B. It will be understood that when an element or layer is referred to as being “on”, “connected to”, “coupled to”, or “adjacent to” another element or layer, it may be directly on, connected to, or coupled to, or immediately adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Although exemplary embodiments of an optical processor have been specifically described and illustrated herein, many modifications and variations will be apparent to those skilled in the art. Accordingly, it is to be understood that an optical processor constructed according to principles of this disclosure may be embodied other than as specifically described herein. The invention is also defined in the following claims, and equivalents thereof.

What is claimed is:

1. An optical processor, comprising:
a free propagation region;
a plurality of input waveguides, coupled to an input aperture of the free propagation region;
a plurality of output waveguides, coupled to an output aperture of the free propagation region;
a first modulator, on one of the input waveguides; and
an optical detector, connected to one of the output waveguides.

2. The optical processor of claim 1, wherein 0.75 microns times a minimum separation between the input aperture and the output aperture exceeds the square of a width of the input aperture.

3. The optical processor of claim 2, wherein 0.25 microns times the minimum separation between the input aperture and the output aperture exceeds the square of the width of the input aperture.

4. The optical processor of claim 1, wherein the first modulator comprises a phase modulator.

5. The optical processor of claim 1, wherein the first modulator comprises an amplitude modulator.

6. The optical processor of claim 5, wherein the first modulator further comprises a phase modulator.

7. The optical processor of claim 1, further comprising an input splitter configured to distribute light from a light source to the input waveguides.

8. The optical processor of claim 1, wherein the spacing of the input waveguides at the input aperture is uniform to within 50%.

9. The optical processor of claim 8, wherein an average pitch of the input waveguides at the input aperture is less than 1.5 microns.

10. The optical processor of claim 8, wherein an average pitch of the input waveguides at the input aperture is greater than 5 microns, and wherein a first contiguous subset of the output waveguides are connected to a first subsystem, and a second contiguous subset of the output waveguides are connected to a second subsystem.

11. The optical processor of claim 10, wherein the first subsystem or the second subsystem is a detector array.

12. The optical processor of claim 10, wherein the first subsystem or the second subsystem is an optical signal processing system.

13. The optical processor of claim 1, wherein the input aperture is concave.

14. The optical processor of claim 1, wherein the input aperture is convex.

15. The optical processor of claim 1, wherein the output aperture is concave.

16. The optical processor of claim 1, wherein the output aperture is convex.

17. The optical processor of claim 1, wherein the input aperture is straight to within 0.5 microns.

18. The optical processor of claim 1, wherein the optical detector comprises a photodetector.

19. The optical processor of claim 1, wherein the optical detector comprises a phase sensitive detector.

20. The optical processor of claim 19, further comprising a phase modulated local oscillator connected to the phase sensitive detector, wherein the phase sensitive detector comprises:
a combiner connected to a signal input of the phase sensitive detector and to the phase modulated local oscillator, and
a photodetector connected to the combiner.
